(19) United States
(12) Patent Application Publication
(10) Pub. No.: US 2024/0408934 A1
(43) Pub. Date: Dec. 12, 2024

(54) Method for Controlling a Cooling System, Control Device, and Motor Vehicle

(71) Applicant: Bayerische Motoren Werke Aktiengesellschaft, Muenchen (DE)

(72) Inventor: Tilman KUEPPER, Muenchen (DE)

(21) Appl. No.: 18/699,751

(22) PCT Filed: Nov. 21, 2022
(86) PCT No.: PCT/EP2022/082547

§ 371 Date: Apr. 9, 2024

(30) Foreign Application Priority Data
Dec. 1, 2021 (DE) 10 2021 131 539.5

(51) Int. Cl. B60H 1/00

(52) U.S. Cl. CPC B60H 1/00278; B60H 1/00885; B60H 2001/00307

(57) ABSTRACT

A method for controlling a cooling system includes providing a motor cooling circuit and providing a battery cooling circuit. In a first operating state, a first radiator is incorporated via a switching device into the motor cooling circuit. In in the first operating state, coolant flows through the motor cooling circuit and the battery cooling circuit fluidically separated from one another. A switch is made to a second operating state by actuating the switching device. Together with the actuation of the switching device, a conveying capacity of the battery circuit pump is reduced and the coolant is guided past the drive battery through the battery bypass line.

### BACKGROUND AND SUMMARY

The disclosure relates to a method for controlling a cooling system or cooling circuits comprising a motor cooling circuit and a battery cooling circuit, wherein a switch is made from an incorporation of a first radiator into the motor cooling circuit to an incorporation of the first radiator into the battery cooling circuit. In addition, the disclosure relates to a control device for carrying out such a method and a motor vehicle having such a control device.

In parallel operation of a motor cooling circuit, in which a drive motor of an electrically driven motor vehicle is cooled by coolant, and a battery cooling circuit, in which a drive battery is cooled, two different temperature levels typically prevail. The battery cooling circuit requires lower temperatures of, for example, 35° C., whereas the coolant in the motor cooling circuit is at a higher temperature level of, for example, 70° C.

If coolant from the motor cooling circuit enters the battery cooling circuit due to an operationally related change of the interconnection of components, the coolant flowing into the battery cooling circuit is then possibly initially too hot for temperature-sensitive components, such as the drive battery.

It is therefore an object of the present disclosure to at least partially eliminate the above-mentioned disadvantages. This object is achieved by a method according to claim 1, a control device according to claim 8, and a motor vehicle according to claim 9. Advantageous refinements of the disclosure are the subject matter of the dependent claims.

According to an exemplary embodiment of the disclosure, a method is provided for controlling a cooling system. The cooling system has a motor cooling circuit, in which flow occurs through a drive motor and a motor circuit pump in a circuit, and a battery cooling circuit, in which flow occurs through a battery circuit pump and a drive battery and/or a battery bypass line parallel to the drive battery in a circuit. In the method, in a first operating state, a first radiator is incorporated via a switching device into the motor cooling circuit. Furthermore, in the first operating state, coolant flows through the motor cooling circuit and the battery cooling circuit fluidically separate from one another. By actuating the switching device, a switch is then made to a second operating state in which a change is made from the incorporation of the first radiator into the motor cooling circuit (5) to an incorporation of the first radiator into the battery cooling circuit and coolant flows through the radiator in the battery cooling circuit, fluidically separated from the motor cooling circuit (5). In addition, together with the actuation of the switching device, a conveying capacity of the battery circuit pump is reduced and the coolant is guided past the drive battery through the battery bypass line. This has the advantage that the inventor has found that significantly faster homogenization, i.e., an equalization of the higher temperature level of the coolant flowing out of the motor cooling circuit into the battery cooling circuit to the coolant temperature of the coolant previously located in the battery cooling circuit takes place due to the slowing of the conveying velocity. This can prevent excessively hot coolant from flowing through the drive battery. The problem could also take place due to a temporary bypass of the drive battery via the battery bypass line, but faster equalization can be achieved by simultaneous reduction of the conveying capacity and thus faster resumption of the cooling function of the drive battery can be effectuated. Due to the reduction of the conveying capacity and the long dwell time of the hot coolant in the first radiator connected thereto, the coolant temperature of the coolant located in the first radiator is equalized to an ambient temperature or a target flow temperature for the drive battery. In addition, a flow of excessively hot coolant from the motor cooling circuit into the battery cooling circuit can have the result that error messages are triggered because the coolant temperature would be too hot to flow through the drive battery. Such error messages can be prevented by the reduction according to the disclosure of the conveying capacity or diagnostic functions can possibly be omitted to avoid error messages.

In particular, the conveying capacity is reduced here by at least 50% in relation to the conveying capacity prevailing up to this point.

The first radiator is an ambient air radiator. The first ambient air radiator is a heat exchanger through which coolant can flow and around and/or through which ambient air can flow (i.e., air surrounding the vehicle), wherein the coolant is cooled by the ambient air.

The chiller or coolant-refrigerant radiator is a heat exchanger through which coolant and refrigerant of a refrigeration circuit (not shown) can flow simultaneously, wherein the coolant and the refrigerant are fluidically separated from one another and are in heat exchange with one another.

According to a further exemplary embodiment of the disclosure, the conveying capacity of the battery circuit pump is increased again after the reduction with decreasing coolant temperature or upon falling below a coolant temperature threshold value at an inlet side of the battery bypass line. As soon the coolant upstream of the drive battery has again reached a temperature level in the battery cooling circuit at which the coolant can be guided through the drive battery again, the conveying capacity is increased again to utilize the full cooling power.

According to a further exemplary embodiment of the disclosure, after the reduction of the conveying capacity of the battery circuit pump upon falling below a cooling temperature threshold value of the coolant at an inlet side of the battery bypass line, a flow through the drive battery is enabled.

According to a further exemplary embodiment of the disclosure, after the actuation of the switching device, a conveying direction of the battery circuit pump is temporarily reversed until a coolant which was located between the first radiator and the switching device until the switching point in time is conveyed through the first radiator. The hot coolant, which has already passed the first radiator at the switching point in time, could thus be guided back to the first radiator once again, thus cooled, and only introduced into the battery cooling circuit after the cooling.

According to a further exemplary embodiment of the disclosure, a chiller is furthermore arranged in the battery cooling circuit.

According to a further exemplary embodiment of the disclosure, a second radiator is furthermore arranged in the motor cooling circuit.

The second radiator is a second ambient air radiator through which coolant can flow in the form of a heat exchanger and around and/or through which ambient air can flow (i.e., air surrounding the vehicle), wherein the coolant is cooled by the ambient air.

According to a further exemplary embodiment of the disclosure, the switching device is a 6/2-way valve.

In addition, the disclosure provides a control device which is adapted to carry out the above-described method. For this purpose, control software which carries out this method is stored in the control device.

Furthermore, the disclosure provides a vehicle having such a control device.

An embodiment of the present disclosure is described hereinafter with reference to the appended drawings. The following is shown in these drawings:

### BRIEF DESCRIPTION OF THE DRAWINGS

FIG. 1a very schematically shows a cooling system according to an exemplary embodiment of the present disclosure in a first operating state;

FIG. 1b very schematically shows the cooling system according to the exemplary embodiment of the present disclosure in a second operating state;

FIG. 2 schematically shows in somewhat more detail the cooling system according to the exemplary embodiment of the present disclosure in the first operating state, and

FIG. 3 schematically shows the cooling system from FIG. 2 in the second operating state.

### DETAILED DESCRIPTION OF THE DRAWINGS

The cooling system according to the disclosure is installed in an electrically driven motor vehicle which is driven solely electrically at least sometimes.

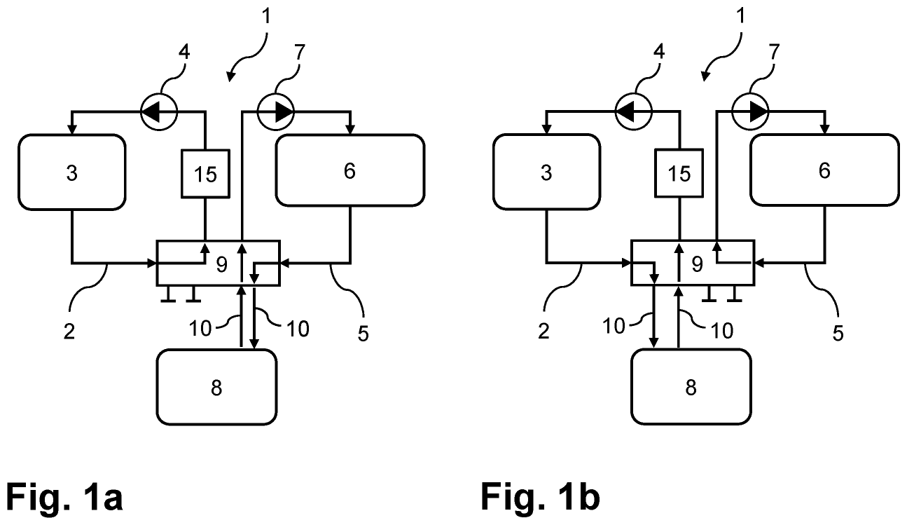

FIG. 1a very schematically shows a cooling system 1 according to an exemplary embodiment of the present disclosure in a first operating state. The cooling system 1 comprises a battery cooling circuit 2, in which coolant flows through a drive battery 3 and a battery circuit pump 4 in a ring. Furthermore, the cooling system 1 comprises a motor cooling circuit 5, in which coolant flows through a drive machine 6 and a motor circuit pump 7 in a ring.

The drive battery 3 has a plurality of electrochemical battery cells, which are electrically connected to one another and are rechargeable. The battery cells store electric energy and thus supply at least the drive machine 6. The drive machine 6 comprises one or more electric motors for driving the motor vehicle.

In addition, the cooling system 1 has a first radiator 8. This can be an ambient air radiator. The first radiator 8 has a single coolant inlet and a single coolant outlet.

The cooling system 1 additionally has a switching device 9, in particular a switching valve or multiple switching valves, using which the first radiator 8 can be alternately incorporated into the battery cooling circuit 2 or into the motor cooling circuit 5.

In the first operating state, the switching device 9 is switched so that the first radiator 8 is interconnected in series via supply and discharge lines 10 in the motor cooling circuit 5 through which flow occurs in a ring.

FIG. 1b very schematically shows the cooling system 1 from FIG. 1a in a second operating state. In this second operating state, the switching device 9 is switched so that the first radiator 8 is interconnected in series via the supply and discharge lines 10 in the battery cooling circuit 2 through which flow occurs in a ring. For this purpose, the switching device 9 is actuated by a control device (not shown) and moved from a first switch position into a second switch position.

The battery cooling circuit 2 and the motor cooling circuit 5 are typically at different temperature levels in operation of the cooling system 1, wherein the temperature level of the motor cooling circuit 5 is higher. For example, the coolant in the battery cooling circuit has a temperature of 35° C. and the coolant in the motor cooling circuit has a temperature of 70° C.

When the switching process from the first to the second operating state is carried out by means of the switching device 9, the coolant at the higher temperature level (for example 70° C.) is still located at the switching point in time in the supply and discharge lines 10 and in the radiator 8. This would be supplied to the drive battery 3 after the switching process and the incorporation connected thereto of the first radiator 8 into the battery cooling circuit. However, the drive battery 3 is temperature-sensitive, because of which such hot coolant flowing through the drive battery 3 is to be avoided.

Therefore, according to the disclosure, a conveying capacity of the battery circuit pump 4 is reduced together or essentially simultaneously, in particular simultaneously, with the switching process of the switching device 9. This results in a slower flow velocity of the coolant in the battery cooling circuit 2 and better homogenization of the temperature, due to which a temperature reduction is achievable faster.

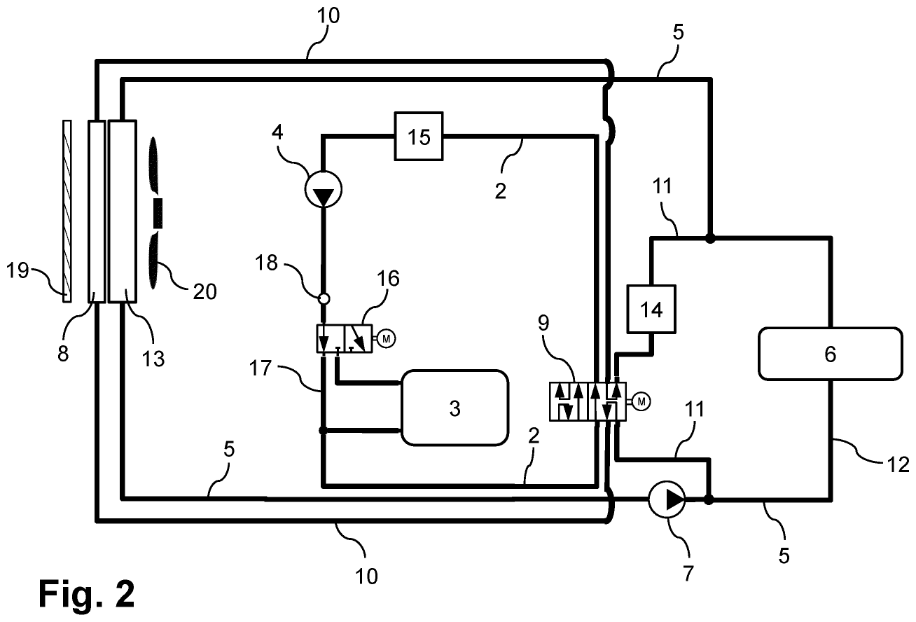

FIG. 2 schematically shows in somewhat more detail the cooling system 1 according to the exemplary embodiment of the present disclosure in the first operating state. In the first operating state, the switching device 9 is in its first switch position, so that the motor cooling circuit 5 is formed, in which the motor circuit pump 7, a parallel circuit made up of a condenser strand 11 and a motor strand 12, and, in series thereto, a second radiator 13 are arranged in series and coolant can flow through them in a ring. The coolant is water admixed with additives, such as a water-glycol mixture. The motor strand 12 has the drive machine 6. The condenser strand 11 in the first operating state is a series circuit made up of switching device 9, supply/discharge line 10, second radiator 13, supply/discharge line 10, and a water-cooled condenser 14. The latter is a coolant-refrigerant condenser, which is a heat exchanger through which coolant and refrigerant of a refrigeration circuit (not shown) can flow simultaneously, wherein the coolant and the refrigerant are fluidically separated from one another and are in heat exchange with one another.

Simultaneously with the motor cooling circuit 5, the battery cooling circuit 2 is formed. Coolant circulates therein in a ring, separated from the motor cooling circuit 5, through a series circuit of a chiller 15, the battery circuit pump 4, a battery valve 16, the drive battery 3 with battery bypass line 17 connected in parallel to the drive battery 3, and the switching device 9. The battery bypass line 17 exclusively bypasses the drive battery 3. Using the battery valve 16, the coolant flow in the battery cooling circuit 2 can alternately be guided through the drive battery 3 and/or through the battery bypass line 17.

At an inlet side of the battery bypass line 17 (in particular upstream of the battery bypass line 17, upstream of the drive battery 3, and downstream of the battery circuit pump 4), a temperature sensor 18 is provided for measuring a coolant temperature. Using this temperature sensor 18, it is possible to monitor at which temperature the coolant flows into the drive battery 3 or, in case of the flow exclusively through the battery bypass line 17, would flow.

An air flap controller 19 and a fan 20 are associated in a known manner with the first radiator 8 and the second radiator 13.

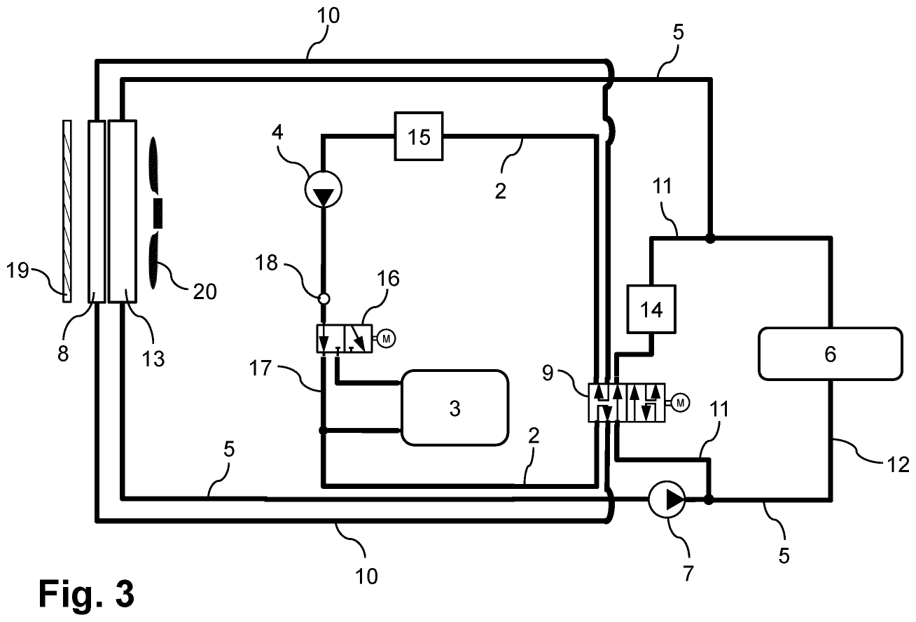

FIG. 3 schematically shows the cooling system from FIG. 2 in the second operating state. In order to change from the first to the second operating state, the switching device 9 is moved from its first into its second switch position by a control unit (not shown). In addition, the battery valve 16 is brought together with the switching device 9 into a switch position in which the coolant is guided through the battery bypass line 17 and thus bypasses the drive battery 3.

Due to the switching over of the switching device 9, the first radiator 8 is no longer incorporated into the motor cooling circuit 5, but instead into the battery cooling circuit 2. More precisely, the condenser strand 11 of the motor cooling circuit 5 is thus formed by a series circuit made up of switching device 9 and water-cooled condenser 14 without the first radiator 8. The battery cooling circuit 2 is formed after the switching over for a specific time span by a series circuit made up of the chiller 15, the battery cooling circuit pump 4, the battery valve 16, the battery bypass line 17, the switching device 9, the first radiator 8, the switching device 9 again, and back to the chiller 15. Coolant can also flow simultaneously through the motor cooling circuit 5 with the battery cooling circuit 2 and fluidically separated therefrom in the second operating state.

According to the disclosure, together with the switching of the switching device 9 from the first operating state into the second operating state, a conveying capacity of the battery circuit pump 4 is reduced in order to achieve better mixing and faster cooling of the coolant upstream of the drive battery 3. The coolant temperature is continuously monitored here by means of the temperature sensor 18 and a flow through the drive battery 3 is permitted again upon falling below a specified coolant temperature threshold value, in that the coolant flow is again guided through the drive battery 3 and no longer through the battery bypass line 17 by switching over the battery valve 16.

In addition, in a temporary starting phase, together with the switching over of the switching device 9, a conveying direction of the battery circuit pump 4 can be reversed in order to convey the coolant which is located in the lines downstream of the first radiator 8 and upstream of the switching device 9 back through the first radiator 8 in order to cool this coolant even faster. At the latest when the coolant located in the mentioned line section was conveyed through the first radiator 8, the conveying direction of the battery circuit pump 4 can be switched back to the normal conveying direction again.

While the disclosure was illustrated and described in detail in the drawings and the preceding description, this illustration and description is to be understood as exemplary and not as restrictive and it is not intended that the disclosure be restricted to the disclosed exemplary embodiment. The mere fact that certain features are mentioned in various dependent claims is not to indicate that a combination of these features could not also advantageously be used.

### LIST OF REFERENCE NUMERALS

1 cooling system
2 battery cooling circuit
3 drive battery
4 battery circuit pump
5 motor cooling circuit
6 drive machine
7 motor circuit pump
8 first radiator
9 switching device
10 supply and discharge lines
11 condenser strand
12 motor strand
13 second radiator
14 condenser
15 chiller
16 battery valve
17 battery bypass line
18 temperature sensor
19 air flap controller
20 fan

1.-9. (canceled)

10. A method for controlling a cooling system comprising:
providing a motor cooling circuit, in which flow occurs in a circuit through a drive motor and a motor circuit pump, and
providing a battery cooling circuit, in which flow occurs in a circuit through a battery circuit pump and a drive battery and/or a battery bypass line parallel to the drive battery, wherein
in a first operating state, a first radiator is incorporated via a switching device into the motor cooling circuit,
in the first operating state, coolant flows through the motor cooling circuit and the battery cooling circuit fluidically separated from one another,
a switch is made to a second operating state by actuating the switching device, in which a change is made from the incorporation of the first radiator into the motor cooling circuit to an incorporation of the first radiator into the battery cooling circuit, and in which coolant flows through the battery cooling circuit, fluidically separated from the motor cooling circuit, and together with the actuation of the switching device, a conveying capacity of the battery circuit pump is reduced and the coolant is guided past the drive battery through the battery bypass line.

11. The method according to claim 10, wherein the conveying capacity of the battery circuit pump is increased again after the reduction with decreasing coolant temperature, or upon falling below a coolant temperature threshold value at an inlet side of the battery bypass line.

12. The method according to claim 10, wherein after the reduction of the conveying capacity of the battery circuit pump, upon falling below a cooling temperature threshold value of the coolant at an inlet side of the battery bypass line, a flow through the drive battery is enabled.

13. The method according to claim 10, wherein after the actuation of the switching device, a conveying direction of the battery circuit pump is temporarily reversed until a coolant which was located at the switching point in time between the first radiator and the switching device is conveyed through the first radiator.

14. The method according to claim 10, further comprising: a chiller that is arranged in the battery circuit.

15. The method according to claim 10, further comprising: a second radiator that is arranged in the motor cooling circuit.

16. The method according to claim 10, wherein the switching device is a 6/2-way valve.

17. A control device, which is configured to carry out the method according to claim 10.

18. A motor vehicle having a control device according to claim 17.
